(19) United States
(12) Patent Application Publication
(10) Pub. No.: US 2003/0198294 A1
(43) Pub. Date: Oct. 23, 2003

(54) Methods and apparatuses for selecting encoding options based on decoding energy requirements

(76) Inventor: Andre Zaccarin, Quebec City (CA)

Correspondence Address: Thomas A. Van Zandt, Blakely, Sokoloff, Taylor & Zafman LLP, Seventh Floor, 12400 Wilshire Boulevard, Los Angeles, CA, 90025-1030, US

(21) Appl. No.: 10/131,704

(22) Filed: Apr. 23, 2002

(51) Int. Cl. H04N 7/12

(52) U.S. Cl. 375/240.16; 375/240.29

(57) ABSTRACT

A method for determining how data will be encoded based upon decoding energy requirements. For one embodiment, a block of data may be encoded using various sets of encoding parameters to achieve a desired performance function. The energy required to decode the data block is evaluated for encoding with each set of encoding parameters. The set of encoding parameters that minimizes decoding energy consumption while satisfying the desired performance function is selected. In alternative embodiments, the performance function is comprised of one or more variables including decoding energy requirements and the set of encoding parameters is selected to maximize the performance function. For one embodiment the encoded data may be decoded to measure the energy required for decoding. In an embodiment, energy-consumption models may be created to evaluate decoding energy requirements for each encoding option.

### NOTICE OF COPYRIGHT

A portion of the disclosure of this patent document contains material which is subject to (copyright) protection. The (copyright) owner has no objection to the facsimile reproduction by anyone of the patent document or the patent disclosure, as it appears in the Patent and Trademark Office patent file or records, but otherwise reserves all (copyright) rights whatsoever.

### FIELD OF THE INVENTION

The present invention relates generally to data encoding and decoding, and more specifically to selection of a data-encoding option in consideration of decoding energy requirements.

### BACKGROUND OF THE INVENTION

Data is encoded in many ways and for various reasons. For example, a system may use a data modulation scheme to transmit data and a data compression scheme to economize data transmission or data storage. Prior to use the data is decoded.

The encoding scheme employed may be selected based upon desired parameters. For example, for a data transmission system with a fixed transmission bandwidth, data may be encoded to achieve a constant bit rate (CBR). The encoding of a video sequence with a CBR constraint may include analyzing the sequence to optimize the use of the available encoding bits. This may include using more bits to encode a dynamic scene while using less to encode a static scene. In this way the quality of the transmitted data is optimized while the CBR transmission is maintained. CBR may not be a concern where data is recorded to a medium. In such a context the data may be encoded using a variable bit rate (VBR). For example, digital video disks (DVDs) are typically encoded using VBR. With VBR, the number of bits necessary to maintain constant quality are encoded.

The way in which the data is encoded may affect the energy consumption upon decoding. Generally the energy required to perform decoding is a function of the computational complexity, that is, the more processing required to decode the data, the more energy required.

This is an especially important consideration for mobile processing systems. Many contemporary devices that provide mobile processing capabilities are extremely energy sensitive. For example, laptop computers, personal digital assistants (PDAs), and mobile telephones are typically powered by batteries that provide limited operating time. Manufacturers continually reduce the size of such devices including the battery size while, at the same time, increasing the processing capabilities and hence energy requirements.

### BRIEF DESCRIPTION OF THE DRAWINGS

The present invention is illustrated by way of example, and not limitation, by the figures of the accompanying drawings in which like references indicate similar elements and in which:

FIG. 1 is a block diagram of an exemplary computing system for implementing an embodiment of the present invention; and

FIG. 2 is a process flow diagram in accordance with one embodiment of the present invention.

### DETAILED DESCRIPTION

For one embodiment, the present invention provides a method for determining how data will be encoded based upon decoding energy requirements. For one embodiment, a block of data may be encoded using various sets of encoding parameters to achieve a desired performance function. The energy required to decode the data block is evaluated for encoding with each set of encoding parameters. The set of encoding parameters that minimizes decoding energy consumption while satisfying the desired performance function is selected. In alternative embodiments, the performance function is comprised of one or more variable including decoding energy requirements and the set of encoding parameters is selected to maximize the performance function.

For one embodiment the encoded data may be decoded to measure the energy required for decoding. In an embodiment, energy-consumption models may be created to evaluate decoding energy requirements for each encoding option (set of parameters).

For example, in typical block-based video compression Motion Picture Expert Group (MPEG) (MPEG standard), video is processed in blocks of 16×16 pixels. A number of encoding parameters are available for each block of data. These parameters include using motion compensation, the size of the block for which motion compensation is done, the number of motion vectors, and the quantization scale that determines the number of coded coefficients. All of these parameters determine the processing and memory operations, and therefore the energy, required by the decoder to decode the data (i.e., reconstruct the video data).

Encoding may be optimized in terms of a performance function that includes bit rate and distortion (a function of the difference between the reconstructed and original data). Typically, optimization may include minimizing distortion given a constant bit rate or minimizing the bit rate for a given distortion. In accordance with an embodiment of the present invention, the energy required to decode the data may be used to optimize encoding. For example, a set of encoding parameters may be selected to minimize decoding energy E, for a given bit rate, R, or to minimize distortion D, for a given decoding energy. One or more variable may be included in the performance function; for example, it may be desired to minimize decoding energy and distortion (E+λD) for a constant bit rate. In general, encoding optimization may be formulated in a number of ways, including but not limited to:

For a given R, minimize E or minimize E+λD

For a given D, minimize E or minimize E+λR

For a given E, minimize R or minimize D or minimize R+λD.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

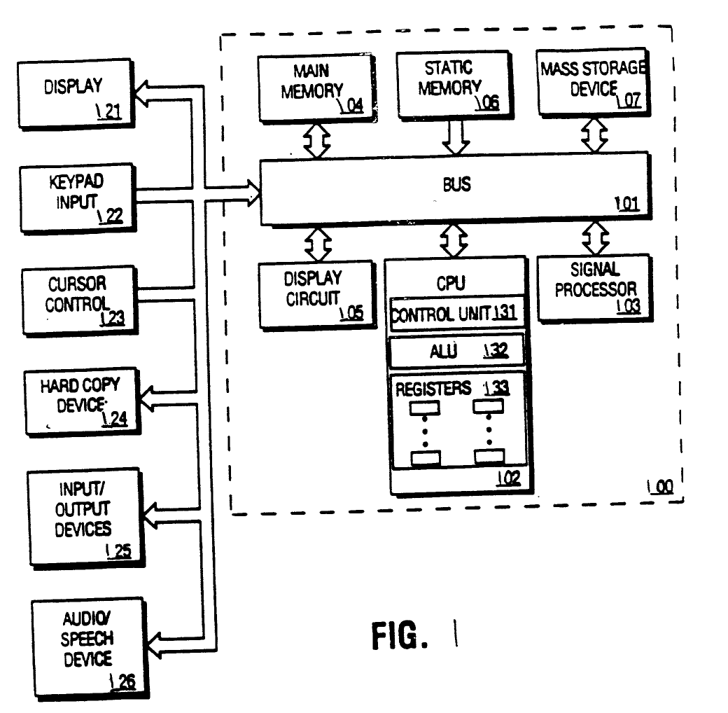

FIG. 1 is a diagram illustrating an exemplary computing system 100 that may be used for implementing an energy-based encoding selection algorithm in accordance with an embodiment of the present invention. The encoding of data, the determination of encoding options to satisfy a performance function, and the evaluation of decoding energy requirements as described herein may be implemented and utilized within computing system 100, which may represent a general-purpose computer, portable computer, or other like device. A computing system encoding data to be decoded upon a mobile computing system (e.g., laptop, PDA, etc.) may encode data using energy minimization as an encoding parameter in accordance with the present invention.

The components of computing system 100 are exemplary in which one or more components may be omitted or added. For example, one or more memory devices may be utilized for computing system 100.

Referring to FIG. 1, computing system 100 includes a central processing unit 102 and a signal processor 103 coupled to a display circuit 105, main memory 104, static memory 106, and mass storage device 107 via bus 101. Computing system 100 may also be coupled to a display 121, keypad input 122, cursor control 123, hard copy device 124, input/output (I/O) devices 125, and audio/speech device 126 via bus 101.

Bus 101 is a standard system bus for communicating information and signals. CPU 102 and signal processor 103 are processing units for computing system 100. CPU 102 or signal processor 103 or both may be used to process information and/or signals for computing system 100. CPU 102 includes a control unit 131, an arithmetic logic unit (ALU) 132, and several registers 133, which are used to process information and signals. Signal processor 103 may also include similar components as CPU 102.

Main memory 104 may be, e.g., a random access memory (RAM) or some other dynamic storage device, for storing information or instructions (program code), which are used by CPU 102 or signal processor 103. Main memory 104 may store temporary variables or other intermediate information during execution of instructions by CPU 102 or signal processor 103. Static memory 106, may be, e.g., a read only memory (ROM) and/or other static storage devices, for storing information or instructions, which may also be used by CPU 102 or signal processor 103. Mass storage device 107 may be, e.g., a hard or floppy disk drive or optical disk drive, for storing information or instructions for computing system 100.

Display 121 may be, e.g., a cathode ray tube (CRT) or liquid crystal display (LCD). Display device 121 displays information or graphics to a user. Computing system 100 may interface with display 121 via display circuit 105. Keypad input 122 may be an alphanumeric input device with an analog to digital converter. Cursor control 123 may be, e.g., a mouse, a trackball, or cursor direction keys, for controlling movement of an object on display 121. Hard copy device 124 may be, e.g., a laser printer, for printing information on paper, film, or some other like medium. A number of input/output devices 125 may be coupled to computing system 100. The process of encoding data by selecting a set of encoding parameters in consideration of the decoding energy requirements in accordance with an embodiment of the present invention may be implemented by hardware and/or software contained within computing system 100. For example, CPU 102 or signal processor 103 may execute code or instructions stored in a machine-readable medium, e.g., main memory 104.

The machine-readable medium may include a mechanism that provides (i.e., stores and/or transmits) information in a form readable by a machine such as computer or digital processing device. For example, a machine-readable medium may include a read only memory (ROM), random access memory (RAM), magnetic disk storage media, optical storage media, flash memory devices. The code or instructions may be represented by carrier-wave signals, infrared signals, digital signals, and by other like signals.

For an alternative embodiment, the algorithm of the present invention may be implemented as dedicated hardware or as a combination of hardware and software.

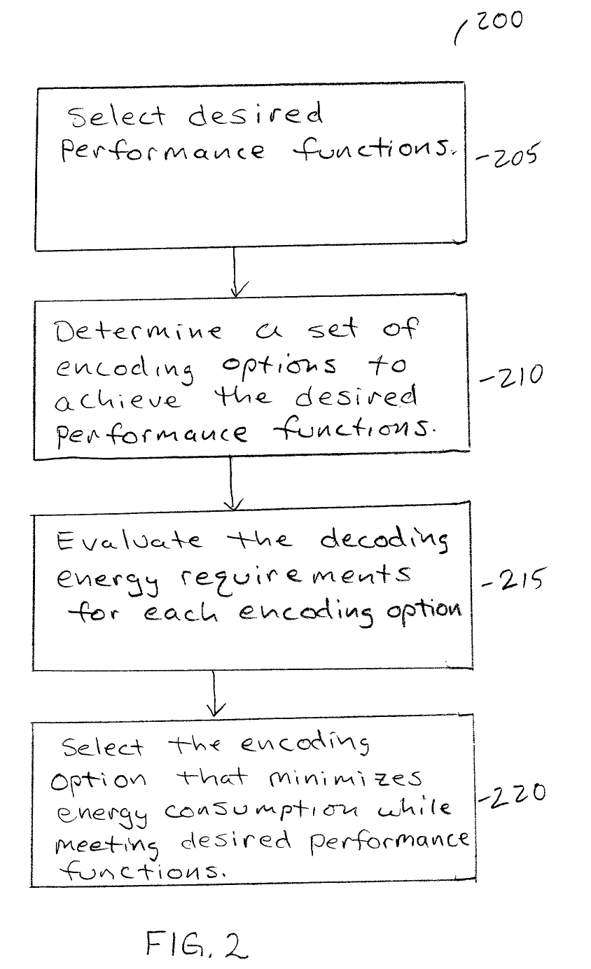

FIG. 2 is a process flow diagram in accordance with one embodiment of the present invention. The process 200, shown in FIG. 2, begins with operation 205 in which a desired performance function is selected. The performance function may include bit rate and distortion (inverse of quality), as discussed above.

At operation 210, a set of encoding options that satisfy the performance function is determined. Each encoding option contains a different set of encoding parameters. For example, MPEG video compression encoding includes frame types like intra (I) frame data, predicted (P) frame data, or bi-directionally predicted (B) frame, as well as different types of blocks of data, known as macroblocks for each of the different types of frames. A desired performance function may be achieved by manipulating the amount of data encoded as I frame data, P frame data, or B frame data or by manipulating the number of blocks of different types in a given frame. For example, encoding/decoding I frame data may be less complex than encoding/decoding P frame data, but may require more bits to achieve the same level of quality. Therefore, the encoder determines how the data blocks will be encoded in order to achieve a performance function that may consider a desired bit rate or a desired quality level (maximum distortion level).

At operation 215 the energy required to decode the data block is evaluated for each encoding option. A data block is encoded using different encoding options. For each encoding option, the energy required to decode the data block is evaluated. The energy used by a given implementation of a decoder to generate reconstructed data from a coded data stream is a function of the actual data values in the stream and the complexity of the processing required for decoding.

For one embodiment, the actual data values and the required processing are modeled. For one embodiment the energy required at the decoder for different encoding options over a set of test data values is measured and the average energy consumption for each encoding option is then associated with that encoding option. This provides a measure of required decoding energy that is independent of the data values. Such an embodiment may be used where it is not possible to evaluate the dependency on the data values (e.g., video compression). For an alternative embodiment, the actual energy required to decode the encoded data may be measured for each encoding option.

At operation 220 the encoding option that minimizes the required decoding energy while satisfying the desired performance function is selected. In alternative embodiments, the performance function is comprised of one or more variable including decoding energy requirements and the set of encoding parameters is selected to maximize the performance function.

An exemplary pseudo-code implementation in accordance with one embodiment of the present invention is included as Appendix A.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

[image]

What is claimed is:

1. A method comprising:
determining a plurality of encoding options for encoding data;
evaluating a decoding energy corresponding to each encoding option; and
selecting an encoding option based upon the corresponding decoding energy.

2. The method of claim 1, wherein the plurality of encoding options are determined such that each encoding option satisfies a specified performance function.

3. The method of claim 2, wherein selecting an encoding option based upon the corresponding decoding energy further comprises selecting an encoding option such that the corresponding decoding energy is minimized.

4. The method of claim 3, wherein the data is encoded to achieve data compression.

5. The method of claim 4, wherein the performance function includes a bit rate and a distortion level as variables.

6. The method of claim 5, wherein the plurality of encoding options include at least one encoding option selected from the group consisting of use of motion compensation, number of motion vectors, use of in-loop filtering, and methods for coefficient prediction.

7. The method of claim 6, wherein at least one encoding option comprises one or more encoding parameters.

8. The method of claim 7, wherein evaluating a decoding energy corresponding to each encoding option further comprises:
determining a number of coded coefficients and a number of memory operations required to decode an encoded data for each encoding option.

9. A method comprising:
determining a plurality of encoding options for encoding data;
specifying a performance function, the performance function including a decoding energy requirement as a variable; and
selecting an encoding option such that the performance function is maximized.

10. The method of claim 9, wherein the data is encoded to achieve data compression.

11. The method of claim 10, wherein the performance function includes a bit rate and a distortion level as variables.

12. The method of claim 11, wherein the plurality of encoding options include at least one encoding option selected from the group consisting of use of motion compensation, number of motion vectors, use of in-loop filtering, and methods for coefficient prediction.

13. The method of claim 12, wherein specifying a performance function further comprises:
determining a number of coded coefficients and a number of memory operations required to decode an encoded data for each encoding option.

14. A machine-readable medium that provides executable instructions which, when executed by a processor, cause the processor to perform a method, the method comprising:
determining a plurality of encoding options for encoding data;
evaluating a decoding energy corresponding to each encoding option; and
selecting an encoding option based upon the corresponding decoding energy.

15. The machine-readable medium of claim 14, wherein the plurality of encoding options are determined such that each encoding option satisfies a specified performance function.

16. The machine-readable medium of claim 15, wherein selecting an encoding option based upon the corresponding decoding energy further comprises selecting an encoding option such that the corresponding decoding energy is minimized.

17. The machine-readable medium of claim 16, wherein the data is encoded to achieve data compression.

18. The machine-readable medium of claim 17, wherein the performance function includes a bit rate and a distortion level as variables.

19. The machine-readable medium of claim 18, wherein the plurality of encoding options include at least one encoding option selected from the group consisting of use of motion compensation, number of motion vectors, use of in-loop filtering, and methods for coefficient prediction.

20. The machine-readable medium of claim 19, wherein evaluating a decoding energy for each encoding option further comprises:
determining a number of coded coefficients and a number of memory operations required to decode an encoded data for each encoding option.

21. A machine-readable medium that provides executable instructions which, when executed by a processor, cause the processor to perform a method, the method comprising:
determining a plurality of encoding options for encoding data;
specifying a performance function, the performance function including a decoding energy requirement as a variable; and
selecting an encoding option such that the performance function is maximized.

22. The machine-readable medium of claim 21, wherein the data is encoded to achieve data compression.

23. The machine-readable medium of claim 22, wherein the performance function includes a bit rate and a distortion level as variables.

24. The machine-readable medium of claim 23, wherein the plurality of encoding options include at least one encoding option selected from the group consisting of use of motion compensation, number of motion vectors, use of in-loop filtering, and methods for coefficient prediction.

25. The machine-readable medium of claim 24, wherein specifying a performance function further comprises:
determining a number of coded coefficients and a number of memory operations required to decode an encoded data for each encoding option.

26. An apparatus comprising a processor with a memory coupled thereto, characterized in that the memory has stored therein instructions which, when executed by the processor, cause the processor to (a) determine a plurality of encoding options for encoding data, (b) evaluate a decoding energy corresponding to each encoding option, and (c) select an encoding option based upon the corresponding decoding energy.

27. The apparatus of claim 26, wherein the plurality of encoding options are determined such that each encoding option satisfies a specified performance function.

28. The apparatus of claim 27, wherein evaluating a decoding energy corresponding to each encoding option includes determining a number of coded coefficients and a number of memory operations required to decode an encoded data for each encoding option.

29. The apparatus of claim 28, wherein the data is encoded to achieve data compression.

30. The apparatus of claim 29, wherein the plurality of encoding options include at least one encoding option selected from the group consisting of use of motion compensation, number of motion vectors, use of in-loop filtering, and methods for coefficient prediction.
